(19) United States
(12) Patent Application Publication
(10) Pub. No.: US 2007/0250372 A1
(43) Pub. Date: Oct. 25, 2007

(54) Computer-assisted system and method for planning tradeshow visits

(76) Inventor: Ivan Arbouzov, Mansfield, TX (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/409,855

(22) Filed: Apr. 24, 2006

(51) Int. Cl. G06F 15/02

(52) U.S. Cl. 705/9

(57) ABSTRACT

A system and method is provided to assist a user going to a tradeshow to make detailed plans for visiting exhibitors at the show. The user may download a show-planning program and a database containing tradeshow information. By running the program, the user can search for exhibitors of interest, contact the exhibitors if desired, and set schedules for visiting exhibitors along selected paths, and identify the visit paths on the exhibition floor map of the tradeshow. Other useful information, such as transportation, hotels, restaurants, and interesting events and activities, may be provided to assist the user in making arrangements for attending the show. The scheduled visit plans can be printed out or downloaded to a portable computing device, which may include a GPS device for guiding the user along a planned visit path through the show floor.

### FIELD OF THE INVENTION

The invention generally relates to tradeshows, and more particularly to a system and method for assisting a user in making plans to visit exhibitors at a tradeshow, and in organizing information received during the show and the follow up.

### BACKGROUND OF THE INVENTION

Tradeshows are a common means for vendors to exhibit their products and services, and for potential customers to meet the exhibitors to gather information on the products and services. Modern tradeshows are often of a very large scale, with hundreds, or even thousands, of vendors from various countries and industries, and many more potential customers attending the show. The physical size of the show and the number of exhibitors can often be overwhelming to a person attending the show.

To make effective use of the time at a tradeshow, a person attending the tradeshow has to have a clear idea of which exhibitors at the show he wants to visit, and make visit plans accordingly. This is particularly important with a large tradeshow that has many exhibitors that are scattered in a seemingly random manner over a large show floor or multiple show locations. Without a clear plan, the person could waste a lot of time wandering around the show floor and miss the opportunities to meet exhibitors that offer products or services that are of interest to him.

Making effective visit plans for a tradeshow, however, is usually not an easy task, and the preparation may require significant time and efforts. For instance, a person (hereinafter the “show attendant”) going to a show may want to find out in advance which exhibitors will be at the show, and identify those exhibitors that are of interest to him. Moreover, the person may want to contact the exhibitors to make appointments for meeting the exhibitors of interest at the show to discuss their products/services or other business opportunities. Collecting information regarding the exhibition and the contact information of the exhibitors for making visit plans for the show, however, can be a difficult and time-consuming task. Also, when the person arrives at the show, he may have to spend a lot of time looking for the exhibition booths of the exhibitors he intends to meet. Furthermore, at a tradeshow, there are often various events and activities, such as presentations, lotteries, and giving away of free samples or gifts, that the person may be interested. The person may, however, miss such events and activities due to a lack of information about them. As a result, it can be somewhat difficult for a show-going person to make effective plans to maximize the effectiveness of the time spent at the show.

### SUMMARY OF THE INVENTION

In view of the foregoing, it is an object of the invention to provide a system and method that can effectively assist a user in making detailed plans for attending a tradeshow to maximize the benefits of going to the show.

It is a related object to provide a system and method that provides information regarding the exhibition at the show and other useful information to allow the user to make effective visit plans and make other related arrangements prior to going to the show.

It is a further related object to provide such a system and method for assisting the user to make plans that is simple and easy to use.

These objects and other related projects are achieved by the present invention, which provides a system and method for assisting user in making visit plans for a tradeshow prior to going to the tradeshow. In accordance with the invention, the user may go to a web server that provides a show-planning program and a database with tradeshow information. The user may download the show-planning program and database to his computer for operation thereon, or use the program and the database on-line. The program allows the user to search for exhibitors of interest, to contact the exhibitors, and to schedule visit paths for meeting the exhibitors at the show. To enable the user to easily find the exhibitors on the show floor, the program presents a map of the tradeshow with the visit paths identified in the map. Other useful information, such as transportation, resources, hotels, restaurants, lotteries at the show, etc., may also be provided for the user to make arrangements related to attending the tradeshow. The visit plans formed with the aid of the show-planning program may be downloaded to a portable computing device, such as a PDA, or printed out. In this way, the user can effectively make detailed visit plans to visit selected exhibitors, and to make other arrangements for the tradeshow, thereby maximizing the benefits of the attending the tradeshow.

The advantages of the invention can be understood from the description of embodiments of the invention set forth below with reference to the drawings, in which:

### BRIEF DESCRIPTION OF THE DRAWING(S)

FIG. 1 is a schematic diagram showing an embodiment of a system in accordance with the invention for a user to make plans for visiting exhibitors at a tradeshow;

FIG. 2 shows a user interface screen displayed by a show-planning program for presenting functions for a user to identify exhibitors of interest and make visit plans;

FIG. 3 shows a user interface screen for presenting information about the tradeshow;

FIG. 4 shows a user interface screen displaying a list of exhibitors attending the tradeshow;

FIG. 5 shows a user interface screen displaying a list of scheduled visit paths and the stop points of the visit paths;

FIG. 6 shows a user interface screen displaying a route of a visit path in an exhibition map for the tradeshow;

FIG. 7 shows a user interface screen for presenting useful information for making arrangements for attending the tradeshow;

FIG. 8 shows a user interface screen for a final review of the scheduled visit plans;

FIG. 9 is a schematic diagram showing a business arrangement of providing a show-planning folder to the user;

FIGS. 10A and 10B are schematic diagrams showing a PDA with a built-in GPS unit and an external GPS unit, respectively; and

FIG. 11 shows a user interface screen displayed by the PDA for guiding a user through a show floor along a predefined visiting path.

### DETAILED DESCRIPTION OF THE INVENTION

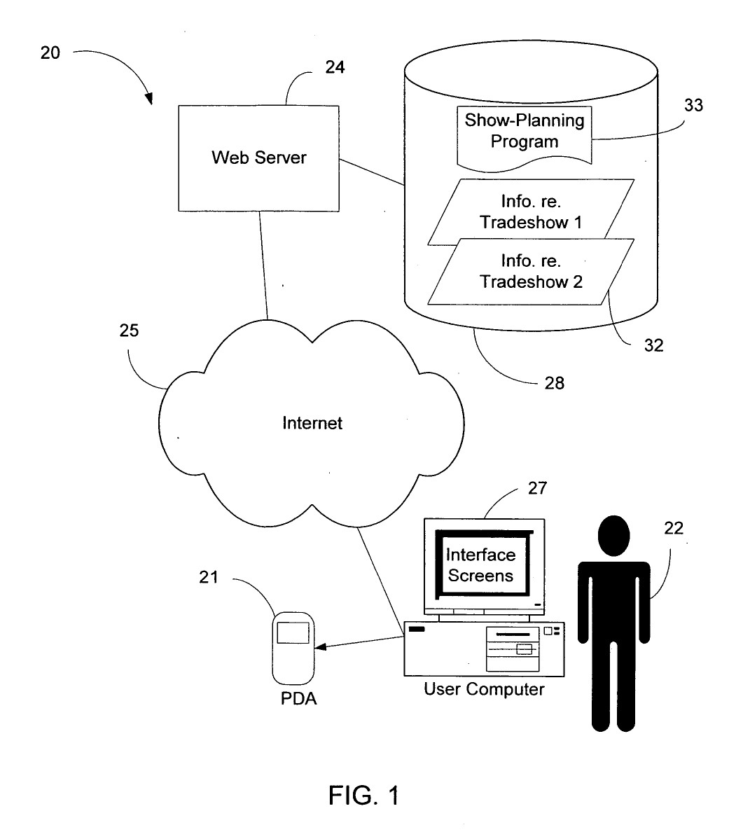

FIG. 1 shows an embodiment of a system 20 in accordance with the invention for assisting a user 22 in making plans for visiting a tradeshow or a similar event. The system includes a web server 24 for a website on the internet 25. A user 22 that desires to learn about a tradeshow and make visit plans for the show has his computer 27 connected to the web server 24 through the internet. Once connected, the web server 24 allows the user to obtain information about the tradeshow, and provides software that the user can run to navigate through the tradeshow information, select exhibitors of interest, and make plans to visit the selected exhibitors at the tradeshow.

In accordance with a feature of an embodiment of the invention, the web server 24 allows the user to download the tradeshow data and a show-planning software program to the user's computer 27. To that end, the web server has a database 28 that stores the tradeshow data 32 and the downloadable show-planning program 33. The database 28 may store data for a plurality of different tradeshows. When the user computer is connected to the server 24, the user may be prompted to identify the particular tradeshow that he intended to attend. To that end, the server 24 may present a list of tradeshows for the user to choose from, and may provide search capabilities for the user to locate a tradeshow of interest according to criteria such as the time, location, size, industry, product/service type, exhibitors at the show, etc.

In accordance with one business model for operating the system of the embodiment, the user 24 may be required to pay a fee for receiving the tradeshow data. The show-planning software 33, on the other hand, may be provided for free. Once the user identifies the tradeshow of interest, the server may prompt the user to enter billing information, such as credit card number, billing address, etc. A different business model for charging the user for the show-planning software and tradeshow data may be implemented. For example, the user may be charged an annual membership fee for accessing the tradeshow data and show-planning software. Once the payment information is confirmed, the server 24 allows the user to download the tradeshow data 32 and the show-planning software 33 to the user computer 27. The downloaded software program and the tradeshow data files are stored in the memory of the user computer 27. At the completion of the downloading operation, the software is installed on the user computer and may be launched automatically.

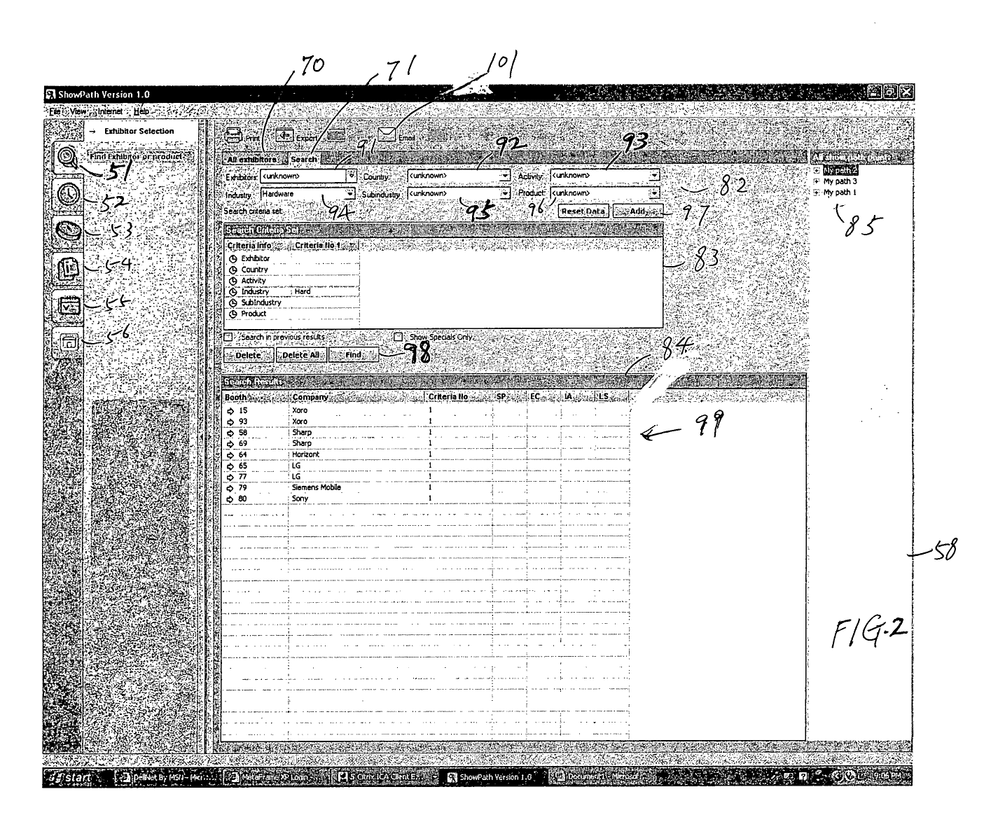

The show-planning program presents various user interface screens to present the tradeshow information to the user and to receive user input for making plans for visiting exhibitors of the show. By way of example, FIGS. 2-8 show various user interface screens presented by one implementation of the show-planning program. Turning first to FIG. 2, the show-planning program provides several main functions selectable by the user for making detailed plans for visiting exhibitors at the show and other arrangements related to attending the show. Those main functions include: Exhibitor Selection, Show Schedule, Show Map, Useful Information, Tradeshow Visit Plan, and Exhibition Info. These functions are represented in the interface screen 58 by corresponding function buttons 51-56, and the user selects a desired function by clicking on the corresponding button. Once a function button is clicked, the program presents an associated user interface screen for that selected function. Each user interface screen may present sub-functions and options related to the selected function. The user interface screen may optionally include an Instruction region that provides a description of various functions that can be used to carry out various operations in connection with the particular user interface screen. The description in the Instruction panel is preferably context-specific in that it is tied to the contents of the specific interface screen. The various functions are described in greater detail below.

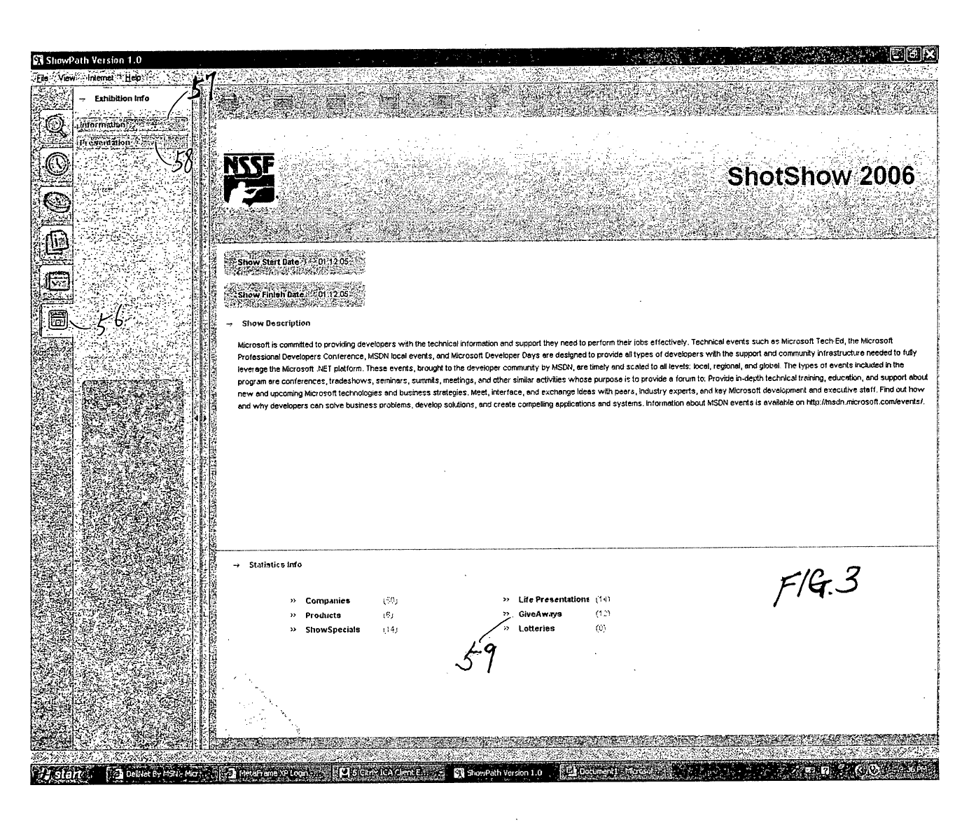

First, the user can view general information about the exhibition by clicking on the “Exhibition Information” button 56. In response, the show-planning program displays a user interface screen that allows the user to select “Information” 57 or “Presentation” 58. When the user selects the “Information” option 57, the program displays, as shown in FIG. 3, information regarding the show, including the start and end dates, a general description about the show, statistical information such as the numbers of companies, products, live presentations at the show, etc., and other information such as information about show specials, give-aways, and lotteries at the show. Each entry of the statistical information may be hyperlinked such that when the user clicks on that entry the program displays information regarding that item For instance, if the user clicks on the “GiveAways” item 59, the program displays further screens that contain information about those give-aways, such as the names and locations of the exhibitors that are giving away free items. When the user selects the “Presentation” option 58, the program displays a screen that describes the presentations given at the tradeshow.

Returning to FIG. 2, by clicking on the Exhibitor Selection button 51, the user can launch a process of selecting exhibitors of interest, and including them in one or more visit plans for the tradeshow. Each visit plan defines one or more visit paths, and each visit path may include the exhibition booths of one or more exhibitors that the user intends to visit.

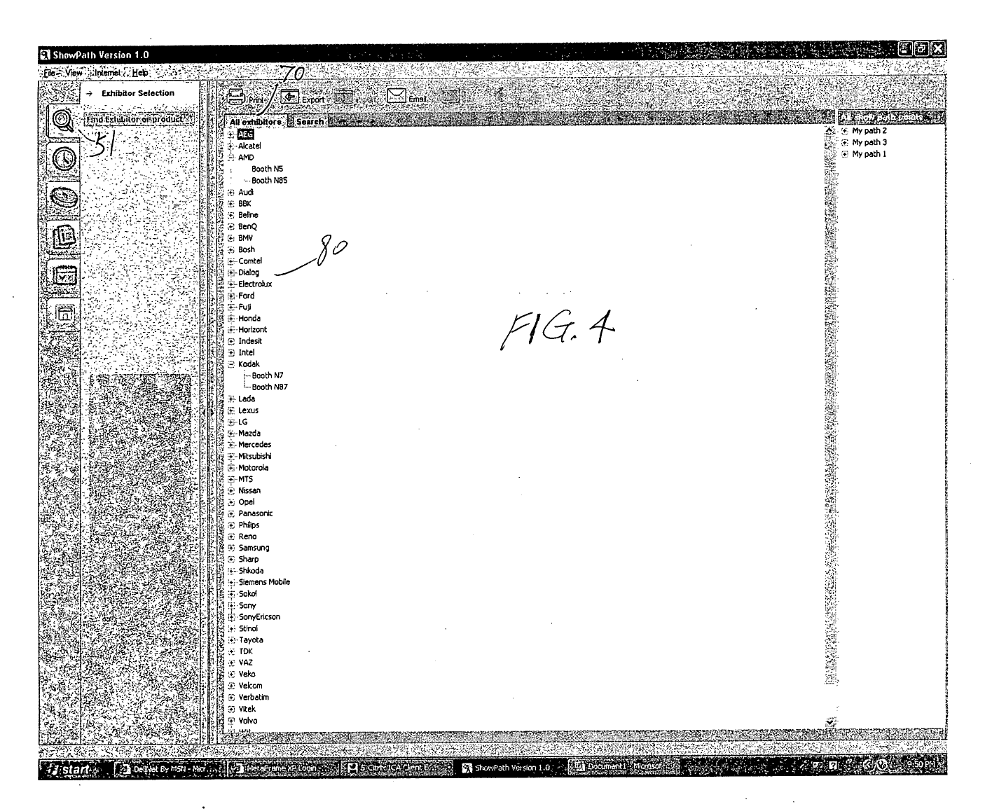

To assist the user in setting up the visit plans, the show-planning program allows the user to view which exhibitors will be at the tradeshow, and to find those exhibitors that he is interested in visiting. In the illustrated example, there are two ways for the user to find exhibitors of interest. First, the user can view and select exhibitors from a complete listing of all exhibitors that are to be at the tradeshow. To that end, the interface screen has an “All Exhibitors” tab 70. When this tab is clicked, the program displays a list 80 of all exhibitors that will be at the show, as shown in FIG. 4. Each exhibitor may have more than one booth at the show, and list shows the booth numbers of all the exhibition booths of an exhibitor when the user selects that exhibitor in the list. The user can go through the list of exhibitors and select those exhibition booths he intends to visit, and include the exhibition booths in one or more visit paths by pressing right mouse button and choosing ‘Add Booth’ from appeared context menu. Selected booth will be added to the selected path in “All paths” tree.

Alternatively, in accordance with a feature of the embodiment, the user can search for exhibitors based on certain specific criteria, and then select exhibitors of interest from the list of exhibitors located by the search. The user selects this option by clicking on the “Search” tab 71 in the user interface screen 58. In response, the program displays a search page that includes a criteria selection region 82, a criteria display region 83, and a search result region 84. The criteria selecting region includes a plurality of criteria selection boxes 91-96, each corresponding to a category of search criteria. In the example shown in FIG. 2, the categories include “Exhibitor,” “Country,” “Activity,” “Industry,” “Sub-industry,” and “Product.” For example, the Country box 92 allows the user to select from a list of countries such as the U.S., Japan, China, etc., and this search criterion is used to find exhibitors from the selected country. Similarly, the Industry box 94 allows the user to search for Exhibitors from a given industry.

To select a criterion, the user clicks on the criteria selection box of a pertinent category. In response, the program displays a list of criteria in that category, and the user selects a criterion from that list by clicking on the criterion. The selected criterion is then displayed in that criteria selection box. By way of example, when the user clicks in the selection box for “Country,” the program displays a list of countries. The user can select one or more criteria from different categories. After a criterion is selected, the user adds that criterion to the search by clicking on the “Add” button 97. The search criterion added by the user is displayed in the criteria display region 83, which displays all the criteria that have been selected by the user for the search. After selecting the criteria, the user initiates the search by clicking on the “Find” button 98. In response, the program goes through the list of all exhibitors to find those that meet the criteria. The result of the search is displayed in the search result region 84. As illustrated in FIG. 2, each exhibitor located in the search may have more than one exhibition booths at the show. The list of the exhibitors 99 shows the booth numbers of each exhibitor, the company name of the exhibitor, a Criterion Number identifying the criterion used to locate this exhibitor, a Special Number that identify the number of specials offered at this exhibition booth, a Presentation Number that shows the number of presentations to be given by this company at that booth, and a Lottery Number that indicates the number of lotteries given by the exhibitor at that booth.

In accordance with an aspect of the invention, the exhibitor selection function also provides contact information of exhibitors to allow the user to contact an exhibitor of interest. To that end, the exhibition information downloaded to the user computer contains contact information for the exhibitors. Once the user finds an exhibitor that he intends to visit, he can use the contact information to contact that exhibitor to ask questions or make an appointment to visit the exhibitor at the tradeshow. Thus, the user can make arrangements for meetings with exhibitors of interest before going to the tradeshow. By way of example, in the embodiment of FIG. 2, after an exhibitor of interest is located, the user can select that exhibitor in the search result table 84, and click the “Email” button 101 in the function bar. In response, the program will generate an email message, using the email address of that exhibitor as the recipient address. In this way, the user can easily communicate with an exhibitor of interest to collect more information or to set up an appointment for meeting the exhibitor at the tradeshow. The contact information of the exhibitors may also be exported to an electronic messaging software program such as the OUTLOOK by Microsoft Corporation or a similar program.

The interface screen of FIG. 2 includes a show path listing area 85 that displays a list of show paths that have been set up by the user. Each show path is an ordered list of booths that the user plans to visit at the show. For example, in the screen shown in FIG. 2 shows that a path named “My Path 1” has five stop points: Booth # 5 of AMD, Booth #23 of Lada, Booth 29# of BMW, Booth #47 of Opel, and Booth #60 of Electrolux. The user can edit each show path to remove or add stop points using either the screen of FIG. 2 or the “Show Plan” screen described below.

After an exhibitor search is performed, the user can select exhibitors that he wants to visit from the search result and add their show booths to one or more show visit paths. There are two ways for the user to add a booth to a show path. The user can select a show booth from the search result list, and drag it to the target show path in the show path list area 85. Alternatively, the user can first select the target show path in the show path list area, and then press the right mouse button over an entry in the search result list. In response, the program displays a drop-down menu, which includes three functions: “Add point,” “Add all points,” and “Show point.” When the user chooses the “Add point” function, the selected booth is added to the selected show path. If the user selects the “Add all points” option, all the booths in the search result table will be added to the selected show path. If user selects some booths in the result list, a new menu item appears after a right mouse button click on the “Add Selected Booths” option. The process of adding booths to a path is done in the same manner for either adding all booths or one booth. The user can select to see the location of an exhibition booth on the show floor by selecting the “Show point” option. In response, the program displays a portion of a map of the show floor containing the selected exhibition booth.

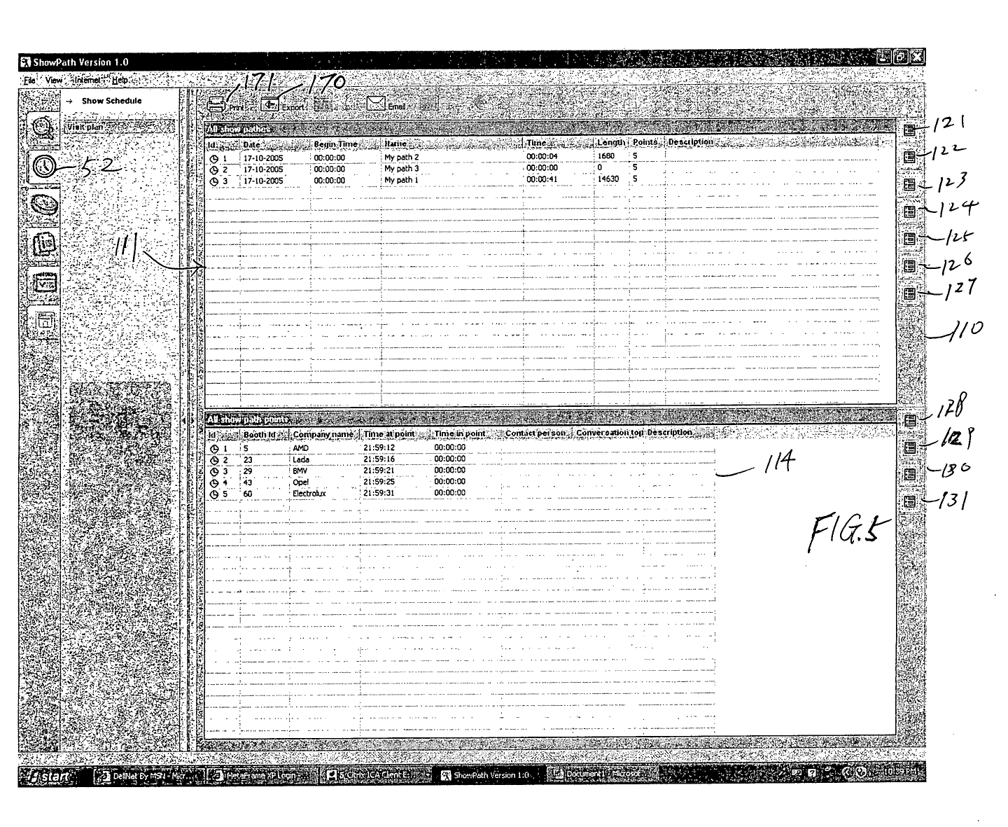

Turning now to FIG. 5, when the user clicks the “Show Schedule” function button 52, the program presents a “Show Schedule” screen 110 that allows the user to view each of the show paths in detail and to edit the paths. An “All Show Paths” table 111 in the screen displays a list of all the show paths that have been set up by the user. The table 111 includes information about each show path, such as the date, name of the path, starting time, total time the path may take, the distance of the path through the show floor, the number of points (booths) to be visited on the path, and a description of the path. When the user selects one path by clicking on the table entry for that path, the “Show Path Points” table 114 displays the exhibition booths to be visited on the path. Each exhibition booth is considered a stop point on the path. Each entry in that table 114 identifies a visit point by its booth ID, name of the exhibitor, time to arrive at that point, time to spend at that point, and other information such as the name of the contact person for that visit point, conversation topics for that visit, and a description of that visit point.

To allow the user to modify the paths, the interface screen 110 provides a plurality of function buttons 121-127, 128, 129, 130, 131. The “Add Path” and “Delete Path” function buttons 121, 122 allow the user to add or delete a path, respectively. When the user clicks the Add Path button 123, the program displays an “Add Path” window, which prompts the user to select the date for a new show path, and to enter the starting time, name, and a description of the new show path. The user can then go to the Select Exhibitor screen to add exhibitor booths of interest to the path. The “Edit Path” function button 123 allows the user to edit the data in the columns of the table 111 for an existing path. The “Merge Path” function 124 allows the user to merge two show paths into one path.

For a selected visit path, the user can edit the data in the columns for a selected stop point by clicking the Edit Point button 128. In response, the program presents an Edit Point window with fields corresponding to the columns for the user to make changes to the data. The Delete Point button 129 is used to remove a selected point from the path. By clicking on the Point Up and Point Down buttons 133, the user can move the entry for the selected point up and down in the list, thereby modifying the order of the point in the visit path.

In accordance with a feature of the embodiment, the program is capable of finding a route through the show floor for a given visit path. In the example shown in FIG. 5, when the user selects a visit path, ‘Use Simple Algorithm’ radio button and clicks on the “Find Path” button 125, the program calculates, based on the floor plan in the downloaded database, a route through the show floor that connects all the visit points in the path in their given order. Alternatively, the user may choose ‘Use Optimal Algorithm’ radio button and click the “Find Path” function button 126. In response, the program calculates the shortest route that connects all the visit points in the path, which may not follow the originally specified order for the visit points.

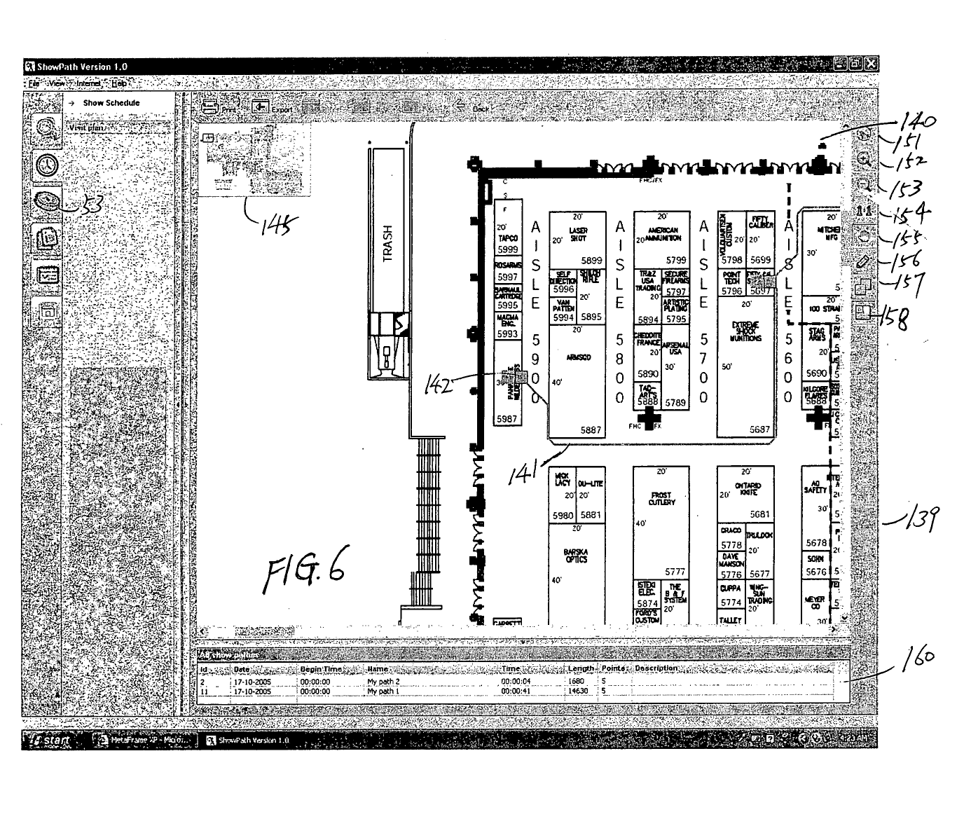

After the user has used either the “Find Path” or “Find Minimum Path,” or another option with this function to find the route for a visit path, he/she can view that route by selecting the “View Path” function button 127. Alternatively, the user may view the map of the exhibition and the visit paths by selecting the “Show Map” function by clicking on the button 53. In response, as illustrated in FIG. 6, the program shows a screen 139 that displays a portion of the tradeshow floor map in a map display region 140. The displayed portion of the map contains the route of a selected visit path, with the route 141 identified therein. In the example illustrated in FIG. 6, the route is shown as colored lines with arrows indicating the travel directions. In the displayed section of the map, each exhibitor booth is identified by its booth number and the exhibitor name. The booths in the displayed section are preferably hyperlinked such that when the user clicks on a booth in the map the program displays information regarding that exhibitor in a pop-up window. When the user finds an exhibition booth on the map that appears interesting, he can right click on the icon for that booth. In response, the program displays options for adding that booth to one or more of the visit plans.

To help the user identify the location of the displayed map section relative to the overall show floor, the program displays a window 144 showing a miniature version 145 of the map of the entire show floor. A rectangle in the miniature map 145 identifies the portion of the show floor currently displayed in the map display region 140. This feature preferably can be turned on and off by clicking on the Mini-Map button 158. Using the scroll bars, the user can move the display region to other portions of the map. Alternatively, the user can click on a point in the miniature map 145, and the program will shift the display region to the corresponding section of the show floor map. The user can also view the whole map if the show floor in the display window by clicking on the “Whole Map” button 151. To facilitate the viewing of the scheduled routes on the map, the user can zoom in or out of the displayed section by using the Zoom-In and Zoom-Out buttons 152 and 153, or return to the original view scale by clicking on the “1:1” button 154.

To enable the user to view the visit paths, a Visit Path region 160 displays a list of existing visit paths. To view a path on the map, the user selects that path in the list. In response, the program displays the section of the show floor map for the entire selected path. The path is identified by a travel line or route 141 in the map that connects all the visit points on the path.

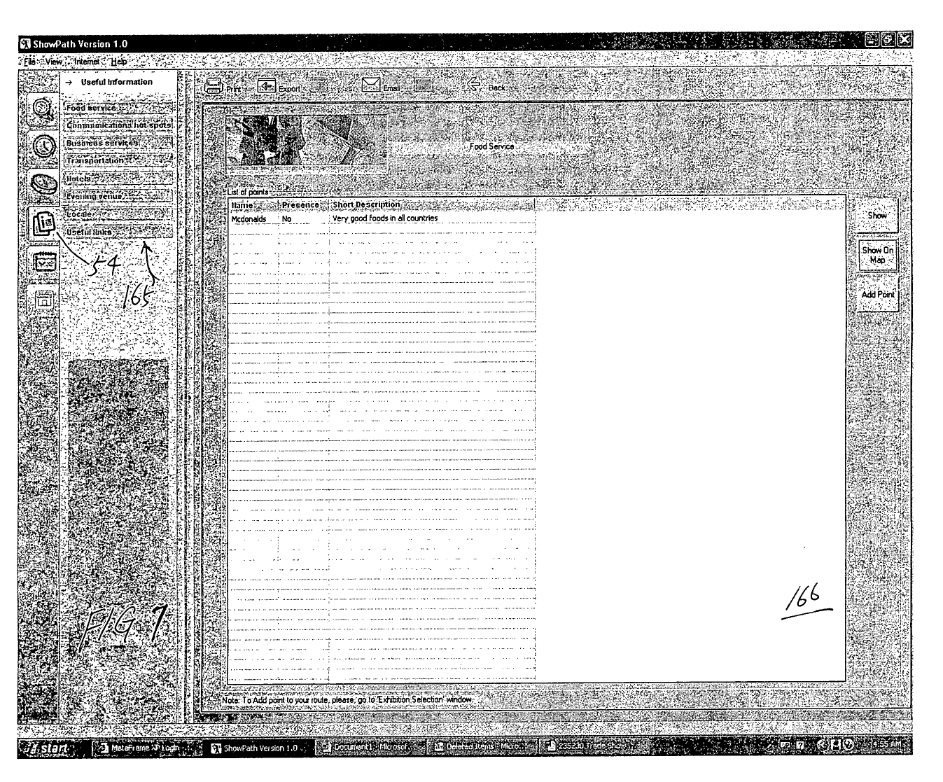

Besides the exhibitor information, the software package also provides other useful information to assist the user in making visit plans for the tradeshow. The information is compiled through investigative work by the service that provides the software package, and is included in the tradeshow database 32. When the user downloads the show-planning software and the tradeshow information database, the information is downloaded and stored on the user computer. To view such information, the user clicks on the “Useful Information” button 54. In response, as illustrated in FIG. 7, the program displays a menu 165 of different information types, such as Food Service, Communication Hot Spots, Business Services, Transportation, Hotels, Evening Venue, Locale, and Useful Links. When the user selects a type of information by clicking on the corresponding menu entry, the program displays the selected information in the display window 166. By making such information readily available, the program can significantly simplifies the task of the user to make plans for activities inside and outside the tradeshow. For instance, with the information provided by the program, the user does not have to perform separate searches to find out about how to get to the show place, which hotel to stay at, where to have lunches or dinners, etc. This information also allows the user to make more effective visit plans for the tradeshow. For instance, the user can decide to have a lunch meeting for a given day at the show, and can include the lunch appointment in the scheduling for the visit path for that day.

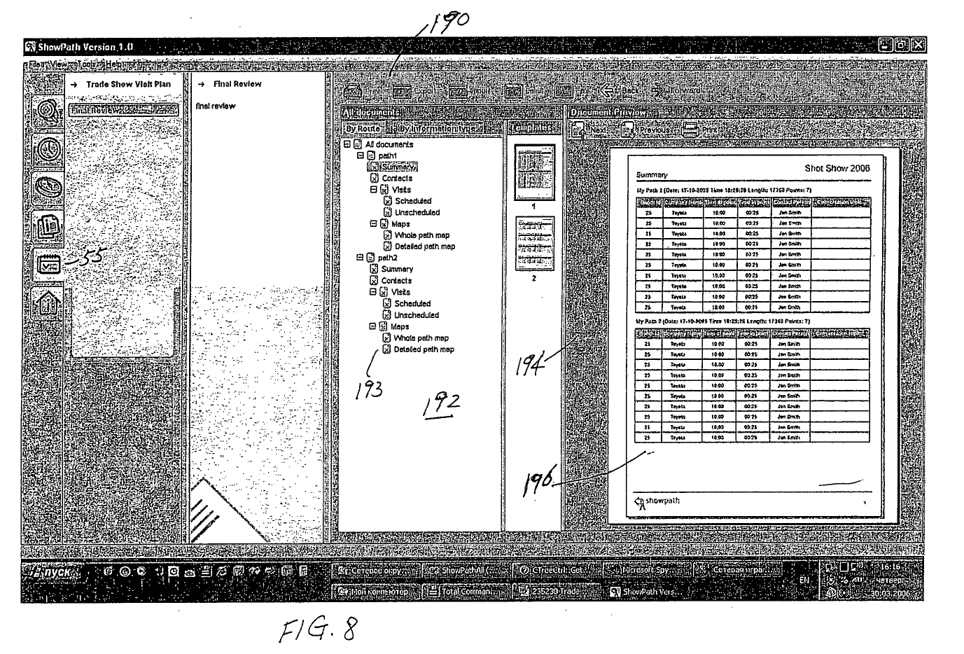

After setting up the visit paths, the user can perform a final review by clicking on the Trade Show Visit Plan button 55. In response, the program displays a screen all the visit paths, and the user can view the details of each visit path in the Path Detail panel, as shown in FIG. 8. The interface screen 190 includes an index pane 192 that organizes the show visiting path information in the form of an index tree 193. For each visiting path, the user can select to view a path summary, contact information, scheduled or unscheduled visits, and maps of the visiting paths. The selected information is displayed in a review window 194. When the user selects to view a path summery, the program displays in the review window 194 a summary table 196 for each visiting path. The summary table identifies for each stop on a visiting path the booth number, exhibitor name, scheduled arrival time and the amount of time to stay at the booth, and the contact person for that booth.

If all visit paths appear to be in good order, the user can download the scheduled visit plans on to a portable computing device, such as a PDA 21 (FIG. 2), by clicking on the Export button 170. In response, the program transmits information of the scheduled show paths and other pertinent information regarding the tradeshow from the user computer 27 to the PDA 21. The transmission of data between the user computer 27 and the PDA 21 may be through a cable or wirelessly. In one embodiment, the information transmitted to the PDA includes a graphic file for each scheduled visit path. The graphic file shows the tradeshow map with the route and visit points of the path identified therein. The graphic file preferably is in a format that the PDA 21 is capable of displaying, such as PDF, TIFF, or JPEG. In this way, there is no need to load a separate software program to the PDA just for the purpose of displaying the visit paths. Alternatively, instead of downloading the information onto a PDA, the user may choose to print out the scheduled visit plans on paper by clicking the Print button 171. In response, the program prints the scheduled visit paths and their routes. Instead of a PDA, the show planning data may be downloaded to other types of portable devices, such as a properly programmed cellular phone or a handheld PC, laptop computer, etc.

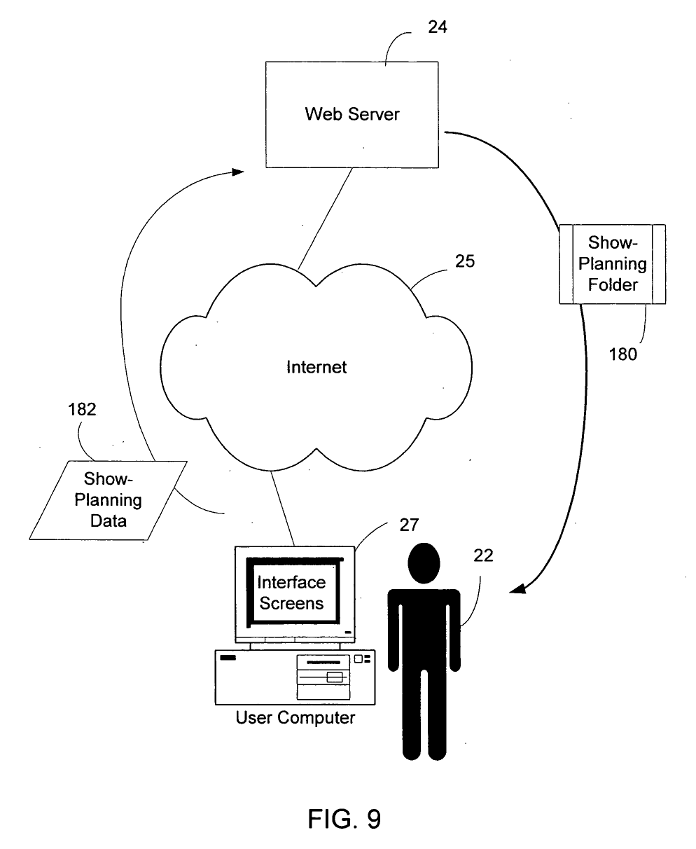

In one embodiment, the company that provides the show-planning software and tradeshow information may also offer the service of providing a folder or organizer to present the scheduled visit plans and other information in an organized manner. For instance, the folder may contain a print-out of the visit plans, with the print-out containing contact information for each stop on the path and providing space for the user to take notes during the visit. In addition, the folder may contain pockets for holding business cards and other features to assist the user in organizing information and documents received during the visits. The folder may be provided by the company to the user for a fee. As shown in FIG. 9, to order the folder 180, the user uploads the scheduled visit paths and other relevant information from his computer 27 to the web server 24. After receiving the show-planning information 182 from the user, the company produces the contents of the folder, and sends the folder 180 to the user by regular or express mail according to the mailing option selected by the user.

In the embodiment described above, the show-planning program and the tradeshow information are both downloaded onto the user computer 27. This arrangement provides the flexibility and convenience of allowing the user to work on the visit plans without having to be connected to the web server. In an alternative embodiment, however, the user does not have to download the program or data. Instead, the user runs the show-planning software on-line to make the visit plans while being connected to the server 24. The results of the show-planning operation may then be printed on a printer connected to the user computer 27, or downloaded to the PDA 21 via the user computer.

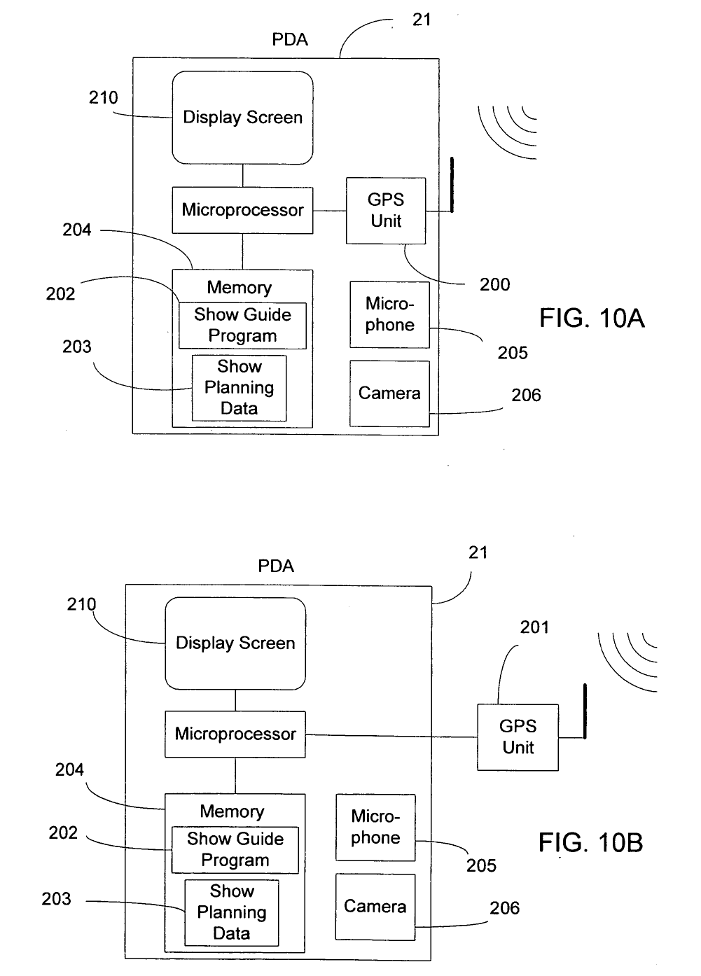

To assist the user in navigating through the show floor, the PDA 21 preferably is quipped with location sensing capability so that it can determine its current location. In one embodiment, the PDA 21 may have a built-in GPS unit 200, as illustrated in FIG. 10A, or is able to be connected to a portable GPS unit 201 either by wire or wirelessly, as illustrated in FIG. 10B. The PDA 21 runs a show guide program 202 that receives the location and orientation information from the GPS unit 200 or 201, and compares that information to the show floor map and visiting paths stored in its memory 204. In this way, the program 202 can determine the current location of the user on the show floor, and the direction the user is moving. The program 202 may be downloaded onto the PDA together with the show planning data 203 from the user computer.

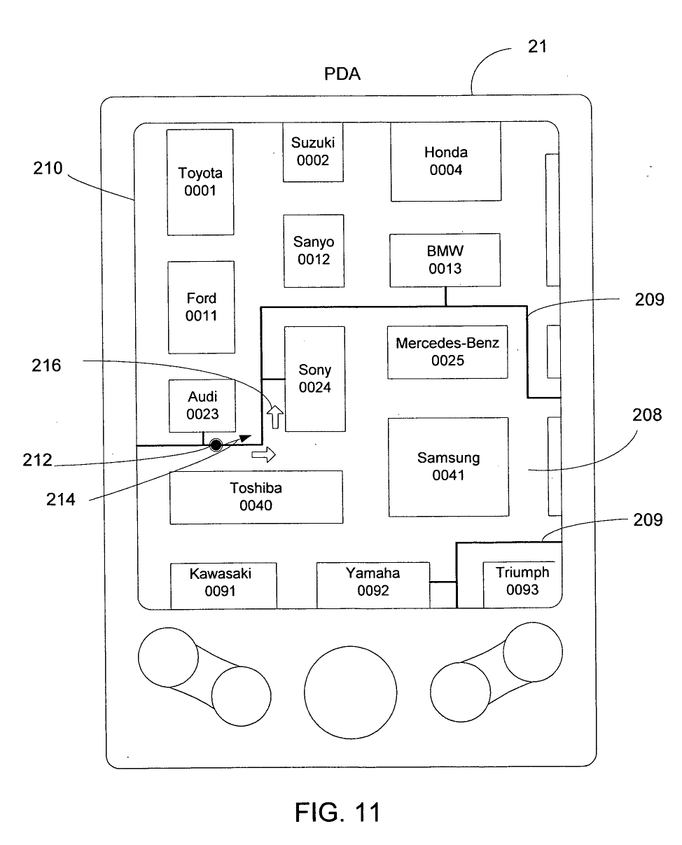

To help the user find his way along a selected visiting path, the program 202 displays a portion the show floor map 208 containing the selected visiting path 209 in the display screen 210 of the PDA 21, as illustrated in FIG. 11. In the displayed map 208, the program 202 identifies the current location 212 of the user and the direction 214 of the user's movement. Features such as a blinking arrow 216 can be used to indicate the direction the user should go in order to stay on the visiting path. Audio signals, such as voice instructions regarding how far to go and where to turn, can also be provided to guide the user along the visiting path 209. The program may also allow the user to use the PDA (or other portable computing devices) to be used for taking notes and recording sound, still images, and video clips. To that end, the PDA may be equipped with a microphone 205 and a video camera 206.

In view of the many possible embodiments to which the principles of this invention may be applied, it should be recognized that the embodiment described herein with respect to the drawing Figures is meant to be illustrative only and should not be taken as limiting the scope of invention. Those of skill in the art will recognize that the elements of the illustrated embodiments can be modified in arrangement and detail without departing from the spirit of the invention. Therefore, the invention as described herein contemplates all such embodiments as may come within the scope of the following claims and equivalents thereof.

1. A system for providing assistance in making visit plans for a tradeshow, comprising:
a web server residing on the internet;
a database connected to the web server and containing a show-planning program and tradeshow information for at least one selected tradeshow, the tradeshow information including a list of exhibitors attending the tradeshow and an exhibition map for the tradeshow, the show-planning program being programmed to provide, based on the tradeshow information, user interface screens and functions for searching for exhibitors, scheduling visit paths for visiting selected exhibitors at the tradeshow, and displaying routes of the scheduled visit paths,
wherein the web server is programmed to download the show-planning program and the tradeshow information for the selected tradeshow to a user computer upon request.

2. A system as in claim 1, wherein the show-planning program is programmed to download scheduled visit plans to a portable computing device.

3. A system as in claim 1, wherein the show-planning program is programmed to perform a search on exhibitors attending the tradeshow based on user-selected criteria.

4. A system as in claim 3, wherein the show-planning program is programmed to provide a function of including a selected exhibitor identified in the search in a scheduled visit path.

5. A system as in claim 1, wherein the show-planning program is programmed to display the exhibition map with a route and stop points of a scheduled visit path indicated therein.

6. A system as in claim 1, wherein the show-planning program is programmed to display a list of visit paths and stop points of the visit paths, and providing the functionality of modifying the visit paths and stop points.

7. A system as in claim 6, wherein the show-planning program is programmed to provide a function of finding a route for a scheduled visit path on the exhibition map.

8. A system as in claim 1, wherein the tradeshow information includes contact information for exhibitors attending the tradeshow, and wherein the show-planning program is programmed to provide the function of generating a communication message to a selected exhibitor based on the contact information.

9. A system as in claim 1, wherein the show-planning program is programmed to download scheduled visit plans and a path guiding program to a portable computing device, the path guiding program being programmed to receive location information indicative of a current location of the portable computing device and display the current location along a predefined visit path on a display screen of the portable computing device for guiding a user to travel along the predefined visit path.

10. A system as in claim 9, wherein the path guiding program is further programmed to provide functionality of recording audio and video signals.

11. A method of making plans for attending a tradeshow, comprising:
downloading a show-planning program and tradeshow information for the tradeshow, the tradeshow information including information of exhibitors attending the tradeshow;
running the show-planning program to perform acts of:
identifying exhibitors of interest using the tradeshow information;
including selected ones of the identified exhibitors in a scheduled visit path; and
displaying a route of the scheduled visit path in an exhibition map of the tradeshow.

12. A method as in claim 11, wherein the act of identifying exhibitors of interest includes performing a search on exhibitors attending the show based on user-selected criteria

13. A method as in claim 11, further including the step of downloading the scheduled visit path and the exhibition map to a portable computing device.

14. A method as in claim 13, further including the steps of sensing a current location of the portable computing device on a show floor, and displaying the current location relative to a predefined visit path on a display screen of the portable computing device.

15. A method as in claim 11, further including the step of printing the scheduled visit path and exhibition map.

16. A method as in claim 11, including the step of finding a route for a scheduled visit path in the exhibition map.

17. A method as in claim 11, including the step of generating a communication message for contacting a selected exhibitor based on contact information included in the tradeshow information.
